(19) United States
(12) Patent Application Publication
(10) Pub. No.: US 2024/0218147 A1
(43) Pub. Date: Jul. 4, 2024

(54) PLASTICIZER FROM WASTE TIRES AND OTHER WASTE RUBBER GOODS

(71) Applicants: Vaibhav Kapoor, Ronkonkoma, NY (US); Arun Kumar Kapoor, Gurugram (IN)

(72) Inventors: Vaibhav Kapoor, Ronkonkoma, NY (US); Arun Kumar Kapoor, Gurugram (IN)

(21) Appl. No.: 18/397,624

(22) Filed: Dec. 27, 2023

Related U.S. Application Data
(60) Provisional application No. 63/461,947, filed on Apr. 26, 2023.
(60) Provisional application No. 63/479,358, filed on Jan. 11, 2023.
(60) Provisional application No. 63/477,641, filed on Dec. 29, 2022.

(51) Int. Cl. C08J 11/12; C08K 5/00

(52) U.S. Cl. CPC C08J 11/12; C08K 5/0016

(57) ABSTRACT

The disclosed inventions include plasticizers having a low Mooney viscosity made from reclaimed and/or devulcanized used rubber materials, for use, as an example, in the manufacture of vehicular tires and other rubber products.

This application claims priority to U.S. Provisional Application No. 63/461,947, filed Apr. 26, 2023; 63/479,358, filed Jan. 11, 2023, and 63/477,641, filed Dec. 29, 2022.

### FIELD OF THE INVENTION

The present disclosure relates to the field of the production of low viscosity plasticizers for use in the manufacture of rubber tires and other rubber goods. In particular, the present disclosure relates to plasticizer compositions comprising devulcanized and/or oxidized cured rubber and low viscosity materials (e.g., bio-oils) and methods of manufacture.

### BACKGROUND

The following discussion is merely provided to aid the reader in understanding the disclosure and is not an admission of prior art.

Existing plasticizers are derivatives of petroleum, having a high content of carcinogenic materials, and all efforts are being made to avoid their use. Some plasticizers with petroleum content are mostly fossil-based and unsustainable. These oils are expensive, and their prices are volatile depending on global oil prices. Some natural or modified natural oils, such as vegetable oils, are being used as alternatives but are very expensive. Also, they put pressure on agricultural land, disturb the food supply chain, and, as such, are not sustainable.

The plasticizers currently available in the market are in liquid form and thus require special care in storage, transportation, and use. This often results in unwanted spillage and damage to the environment.

There is a need for plasticizers in the rubber industry which are substantially free from petroleum oils, substantially free from aromatics, and are REACH compliant and sustainable. Further, there is a need for recycling waste tires and other rubber products so as to support a sustainable circular economy and prevent environmental damage. There is also a need for affordable and sustainable raw materials with stable prices unaffected by the global ups and downs of oil supply and prices. Thus, there is a need for a sustainable, non-petroleum-based plasticizers in the tire and rubber products industries.

The present inventions employs recycled waste, used tires, and used waste rubber products for the manufacture of new tires and other rubber products, promoting a circular economy. They are not as affected by global petroleum prices and are stable and cost-effective. The plasticizers of the inventions described herein result in little or no spillage, cheaper transportation, and more efficient storage and stocking. The inventions described herein also improve the tires' and rubber products' physical properties when used as a partial or full replacement for petroleum-based plasticizers. The manufacturing processes to manufacture such plasticizers are such that they produce more consistent products with more consistent Mooney viscosity, without the use of refining and without any wasteful byproducts or low-grade materials, also known as tailing.

In sum, the inventions described herein are sustainable, environmentally friendly, substantially petroleum oil-free, allowing for low and stable costs and convenient handling, including cheaper and easier transportation, and easier storage along with other raw materials.

### Definitions

As used in the description of the invention, the singular forms “a”, “an” and “the” are used interchangeably and intended to include the plural forms as well, unless the context clearly indicates otherwise. Also, as used herein, “and/or” refers to and encompasses any and all possible combinations of one or more of the listed items, as well as the lack of combinations when interpreted in the alternative (“or”).

As used herein, the term “about” will be understood by persons of ordinary skill in the art and will vary to some extent depending upon the context in which it is used. If there are uses of the term which are not clear to persons of ordinary skill in the art given the context in which it is used, “about” will mean up to plus or minus 10% of the particular term.

The term “PHR” means Per Hundred Rubber.

The term “TBR” means Truck Bus Radial.

“DV” means de-vulcanizer.

“RA” is a reclaiming agent.

“Mooney Viscosity” is defined per ASTM D1646 as the shearing torque resisting rotation of a cylindrical metal disk (or rotor) embedded in rubber within a cylindrical cavity. The dimensions of the shearing disk viscometer, test temperatures, and procedures for determining Mooney viscosity are defined in these test methods.

“Bio-oil” means edible and non-edible plant or animal based oils, including but not limited to the Bio-oils identified below.

“RSC Plast” is a tradename for certain plasticizers of the inventions described herein.

### SUMMARY OF THE INVENTION

The inventions described herein involve the devulcanization and/or oxidation of rubber products that reduces the molecular weight of rubber molecules and thus converts elastic tire rubber (and other rubber products) into soft, pliable materials which behave like a lubricant or softener (plasticizer) in a rubber compound mixture.

In one embodiment, the plasticizer of the invention is a plasticizer comprising a devulcanized and/or oxidized rubber having a Mooney viscosity of about 20 or less, preferably about 15 or less, or about 12 or less, or about 10 or less. Preferably the Mooney viscosity should be no less than about 5, or no less than about 8.

In another embodiment, the plasticizer of the invention also comprises a reclaiming agent, preferably the reclaiming agent is Di-xylyl-di-sulphide and similar di-sulphides, more preferably the reclaiming agent is an Alkylphenol Desulfurized Oligomer.

In another embodiment, the plasticizer of the invention also comprises Bio oil/oils, for example vegetable oils, nut oils, shell oils, plant oils, bush oils, pine tar, tall oil, castor oil, soybean, sunflower oils, cashew nut shell oil, turmeric oil, Avocado oil, Jojoba wax, Jojoba oil, flaxseed oil, and grape seed oil. Other Bio-oils that may be used include groundnut, rapeseed, cottonseed, corn, chrysalis, sunflower, tobacco, perilla, safflower, poppyseed, rubberseed, tall oil, tung, linseed, whale, seal, cod liver, herring, sardine, shark, and other modifications thereof and comparable Bio-oils.

In another embodiment, the plasticizer of the invention also comprises Crumb rubber preferably of about 10 mesh or finer, about 30 mesh or finer, about 40 mesh or finer, about 60 mesh or finer, about 80 mesh or finer, about 100 mesh or finer, about 120 mesh or finer, or about 200 mesh or finer. Preferably, the mesh size is about 30 to about 80, more preferably, about 40 to about 60.

In another embodiment, the invention includes a process for making a plasticizer for use in manufacturing rubber products such as tires, conveyor belts, molded rubber products, and others by devulcanizing and/or oxidizing used rubber until its Mooney viscosity is about 20 or less, preferably about 15 or less, or about 12 or less, or about 10 or less. The devulcanization and/or oxidation process can include the addition of a reclaiming agent, such as for example, the reclaiming agents referred to above, and can include the addition of oils, such as for example, the Bio-oils referred to above. The devulcanization process can also include the application of heat, high pressure and mechanical shear and/or a combination of these.

The application of heat during the process may include maintaining a sufficiently high temperature for a period of time so as to reduce the Mooney viscosity of the raw material (waste/used rubber) to about 20 or less, preferably about 15 or less, or about 12 or less, or about 10 or less. Preferably the Mooney viscosity should be no less than about 5, more preferably, no less than about 8.

The foregoing general and following detailed descriptions are exemplary and explanatory and are thus not intended to limit the claimed inventions but are intended to provide explanations and descriptions of the inventions as claimed. Other objects, advantages, and novel features will be readily apparent to those of ordinary skill in the art to which the inventions pertain.

### BRIEF DESCRIPTION OF DRAWINGS

FIG. 1 depicts some processes of making the inventions described herein.

FIG. 2 depicts other processes of making the inventions described herein.

### DETAILED DESCRIPTION

The present inventions preferably utilize two chemical reactions simultaneously: a) process of oxidation of rubber materials to cut C-C chains and b) process of devulcanization which causes cleavage in poly-sulphedinic linkages created during vulcanization of rubber products. The oxidation and/or devulcanization is carried out so that the final products (plasticizers), preferably have a Mooney viscosity value of about 20 or less, preferably about 15 or less, or about 12 or less, or about 10 or less. Preferably the Mooney viscosity should be no less than about 5, more preferably, no less than about 8.

The oxidation and/or devulcanization is preferably conducted on crumb rubber made from used tires and/or other rubber products and the material obtained (plasticizers) is in a sheet, noodle, pellet, lump or gel form or any combination of these.

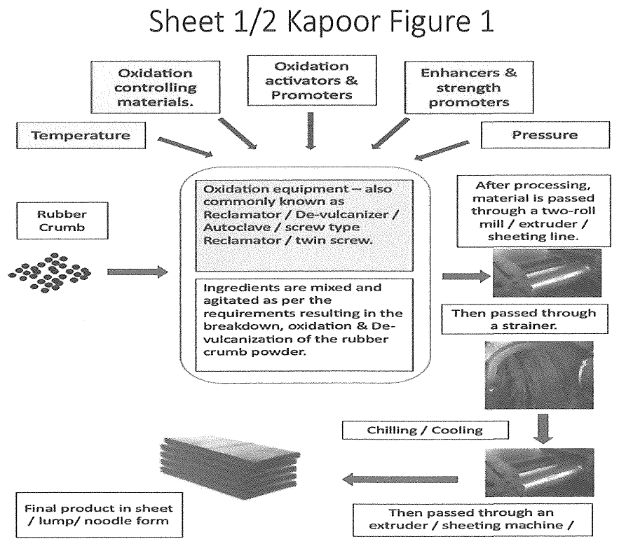

In the embodiments depicted in FIG. 1, crumb rubber may be added 40 mesh or finer to the equipment for devulcanization and/or oxidation. About 2 to 30 parts by weight of Bio-oil/oils is/are added in the rubber powder at this stage. The container may be an autoclave, a reclamator, a devulcanizer, a single screw, or a twin-screw extruder. Oxidation and/or devulcanization controlling materials, oxidation and/or devulcanization activators and promotors, and enhancers and strength promotors may be added as well. The mixture is heated and agitated resulting in the breakdown and devulcanization and/or oxidation of the cured rubber material. The temperature inside the container may be raised to at least about 130° C. and can go up to about 380° C. for the required time sufficient to lower the Mooney viscosity to acceptable levels. The resulting material may be passed through a two-roll mill and/or an extruder/strainer and/or a sheeting machine and or pelletizer, and then may be cooled to bring the temperature to room temperature or less, e.g., below about 20° C., or below about 15° C., or below about 10° C., and then packaged as sheets, gels, lumps, pellets and/or strings and/or combination thereof.

Examples of suitable oxidation controlling materials include carbon dioxide, Nitrogen, steam and other similar materials.

Examples of suitable oxidation activators and promoters include compressed air (oxygen), Sulphides such as Di-Aryl-Di sulphides, and other similar materials.

Examples of suitable enhancers and strength promotors include tall oil, cashew nut shell oil, pine tar and other similar materials. Other Bio-oils may be used as described above.

Examples of cooling are using a chiller or dry ice, chilled two-roll mill and/or an extruder/strainer and/or a sheeting machine and/or pelletizer.

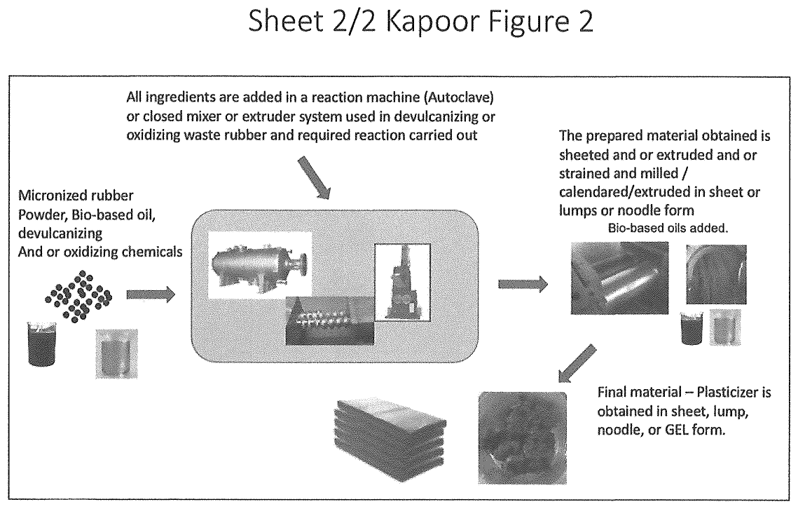

In the embodiments depicted in FIG. 2, micronized rubber powder (about 40 mesh or finer) is added to a container for devulcanization and/or oxidation. The container may be an autoclave, a mixer or an extruder system. Oxidizing and/or devulcanizing and/or reclaiming agents of the types discussed above may be added as well, and in addition, oils of the type discussed above can also be added. These various pieces of equipment can employ heat, pressure and mechanical shear so as to reduce the Mooney viscosity to acceptable levels. The temperature inside the container may be raised to at least about 130° C. for a period of time sufficient to lower the Mooney viscosity. After completion of the reaction, the material may be cooled or chilled to room temperature or lower, for example, about 25° C. or less, about 20° C. or less, about 15ºC or less, or about 10ºC or less. The material may be packaged as sheets, gels, lumps, pellets, strings, noodles, or a combination of these.

The minimum temperature in the processes of the invention may preferably be at least about 130° C., or at least about 160° C., or at least about 170° C., or at least about 180° C., or at least about 190° C., or at least about 200° C., or at least about 210° C., or at least about 220° C., or at least about 230° C., or at least about 240° C., or at least about 250° C. The maximum temperature may preferably be at most about 380° C., or at most about 250° C., or at most about 220° C., or at most about 200° C.

The temperatures above may preferably be maintained for at least about 1 hour, or at least about 2 hours, or at least about 3 hours, or at least about 4 hours, or at least about 5 hours, or at least about 6 hours. Preferably, the above temperatures may be maintained for at most about 8 hours. In case of screw type reclamater the reaction time may preferably be between 2.5 min to 7.5 min at 300 to 350° C. with or without any oxidizing promoters/agents. After the reaction the material is cooled to room temperature or below before it is discharged for further processing.

### EXAMPLES

The following are merely examples of the inventions described herein and are not intended and should not be used to limit the scope of the claims.

### Example 1

An example of a plasticizer composition of the invention is shown in Table 1.

TABLE 1

| Material | Wt. (kgs) | PHR |
|---|---|---|
| Whole tire TBR* 40 mesh | 4000 | 100.00 |
| Reclaiming agent (ADO**) | 38 | 1.00 |
| CNSL*** | 100 | 2.50 |
| | 4138 | 103.50 |

*Truck Bus Radial Tire Rubber.
**Alkylphenol Desulfurized Oligomer
***Cashew nutshell liquid

Below in Table 2 is the process used to manufacture the plasticizer of Example 1:

TABLE 2

| | Steps/Process | Time | |
|---|---|---|---|
| 1 | All ingredients are loaded in the vulcanizer-rotary autoclave | 45 | min |
| | simultaneously. Crumb, then oil, followed by a reclaiming agent. | | |
| 2 | The vessel (DV) after having been loaded with rubber powder etc. is | 45 | min |
| | filled up with steam. | | |
| 3 | Open the steam to 14 kg/cm2 (ATU). The temperature is maintained at | 180 | min |
| | @170° C. for 3 hrs. (cooking time). | | |
| 4 | Steam is released, and the autoclave is opened to allow the balanced | 10 | min |
| | moisture to escape and the material to cool down. | | |
| 5 | The bottom of the DV is opened, and the material is discharged to the | 30-60 | min |
| | floor. The dump temperature is 40° C.-45° C. | | |
| 6 | The material is moved to a mixing mill or a pre-refiner - about 1-2 | 5 | min |
| | rounds forming sheets. | | |
| 7 | After forming the sheet, the material is moved through a strainer | 5 | min |
| | (using 40-60 mesh sieve), and the noodles are formed. | | |
| 8 | The material is - fed into a refiner - - and then sheeting is carried on | 5 | min |
| | another similar refiner. | | |
| 9 | The final material is packed as per the required form and quantity. | | |

Final product properties: Moony viscosity is about 10 to 14.

The plasticizer of Example 1 was added into four different rubber compounds (Experiments 01-04) with the compositions shown in Table 3 and test results shown in Table 4. A standard rubber formulation is shown in the left most column (entitled “Running”) for comparison.

TABLE 3

| | | Experiment | Experiment | Experiment | Experiment |
|---|---|---|---|---|---|
| | Running | 01 | 02 | 03 | 04 |
| Ingredients | PHR | PHR | PHR | PHR | PHR |
| SIR-20 | 100.00 | 100.00 | 100.00 | 100.00 | 100.00 |
| PEPTIZER | 0.30 | 0.30 | 0.30 | 0.30 | 0.30 |
| N330 | 62.00 | 62.00 | 62.00 | 59.00 | 59.00 |
| Plasticizer | — | 20.00 | 20.00 | 10.00 | 10.00 |
| (Invention) | | | | | |
| Oil 380 low PCA | 15.00 | 5.00 | — | 5.00 | 7.00 |
| (Petroleum | | | | | |
| plasticizer) | | | | | |
| ZnO | 5.00 | 5.00 | 5.00 | 5.00 | 5.00 |
| St Acid | 2.75 | 2.75 | 2.75 | 2.75 | 2.75 |
| MS 40 (Zincolite) | 2.50 | 2.50 | 2.50 | 2.50 | 2.50 |
| SP 1068 | 1.00 | 1.00 | 1.00 | 1.00 | 1.00 |
| TDQ | 1.50 | 1.50 | 1.50 | 1.50 | 1.50 |
| TBBS | 1.00 | 1.00 | 1.00 | 1.00 | 1.00 |
| Sulphur | 1.40 | 1.40 | 1.40 | 1.40 | 1.40 |
| Insoluble Sulphur | 1.75 | 1.75 | 1.75 | 1.75 | 1.75 |
| PVI | 0.25 | 0.25 | 0.25 | 0.25 | 0.25 |
| Total | 194.45 | 204.45 | 199.45 | 191.45 | 193.45 |

TABLE 4

| Curing | | | | | |
|---|---|---|---|---|---|
| condition | Running | 01 | 02 | 03 | 04 |

Rheological Properties

| | 151° C., 30 mins-Average Values | | | | |
|---|---|---|---|---|---|
| ML | 9.55 | 11.67 | 12.23 | 12.84 | 12.86 |
| MH | 33.15 | 34.38 | 37.38 | 35.54 | 35.86 |
| Ts2 | 4.97 | 3.28 | 3.07 | 3.16 | 3.20 |
| Tc90 | 10.43 | 8.77 | 8.72 | 8.92 | 8.85 |

Physical properties:

| | 151° C., 25 mins-Average Values | | | | |
|---|---|---|---|---|---|
| 100% Mod Kg/cm² | 30 | 35 | 42 | 34 | 35 |
| 300% Mod (Spec < | 93 | 132 | 134 | 130 | 131 |
| 90 ± 10 Kg/cm²) | | | | | |
| TS (Spec < 150 ± 10 | 144 | 181 | 186 | 191 | 193 |
| Kg/cm²) | | | | | |
| EB % (Spec < | 433 | 410 | 403 | 425 | 435 |
| 450 ± 50) | | | | | |
| Hardness (Spec | 65 | 70 | 72 | 71 | 70 |
| 65 ± 3 snore A) | | | | | |
| Mooney (52 ± 2) | 54 | 61 | 68 | 66 | 63 |
| Sp. Gravity | 1.14 | 1.16 | 1.16 | 1.15 | 1.15 |
| | Ageing Test 100° C. for 72 hrs.-Average Values | | | | |
| 100% Mod Kg/cm² | 38 | 46 | 59 | 47 | 47 |
| TS Kg/cm² | 62 | 89 | 90 | 90 | 90 |
| EB % | 153 | 148 | 135 | 152 | 151 |
| Hardness | 70 | 77 | 78 | 78 | 76 |
| | Retention % | | | | |
| 100% Mod | 20.6 | 24.35 | 29.27 | 27.5 | 25.5 |
| TS Kg/cm² | −57.26 | −51.04 | −51.38 | −52.76 | −53.34 |
| EB % | −64.57 | −63.87 | −66.5 | −64.3 | −65.28 |

The test results shown above in Table 4 demonstrate that rubber materials made using the plasticizers of the invention have higher modulus, tensile strength, hardness and better aging properties, and can be accomplished at a lower cost.

### Example 2

Shown in Table 5 is another example of the plasticizer composition of the invention.

TABLE 5

| Material | Wt. (kgs) | PHR |
|---|---|---|
| Whole tire TBR* 40 mesh | 4000 | 100.00 |
| Reclaiming agent (ADO**) | 40 | 1.00 |
| CNSL*** | 2000 | 50.00 |
| | 6040 | 151.00 |

*Truck Bus Radial
*Alkylphenol Desulfurized Oligomer
***Cashew nutshell liquid

Here in Table 6 is the process to manufacture plasticizer of Example 2:

TABLE 6

| | Steps/Process using DV | Time |
|---|---|---|
| 1 | All ingredients are loaded in the vulcanizer-rotary autoclave | 45 min |
| | simultaneously. Crumb, then oil, followed by RA. | |
| 2 | Steam is fed into DV | 45 min |
| 3 | The steam is opened. The temperature is maintained at between 160° C. | 180 min |
| | −220° C., which is kept for 3 hrs. (cooking time). | |
| 4 | Steam is released, and the autoclave is opened to allow the balanced | 10 min |
| | moisture to escape through open door | |
| 5 | Due to steam evaporation the material cools and is discharged from | 30-60 min |
| | bottom of the DV for further processing. | |
| 6 | The material is moved to a mixing mill or a pre-refiner for about 1-2 | 5 min |
| | rounds while balance Bio-oil is added. | |
| 7 | After forming the sheet or gel, the material is moved through a strainer | 5 min |
| | (40-60 mesh sieve), and the noodle/gel is formed. | |
| 8 | The material is packed in woven sacks or bags (Eva bags). | 5 min |
| 9 | The final material is packed as per the requirement. | |

Final product properties: Mooney viscosity 8-13, which is achieved without any waste/tailing.

The plasticizer of Example 2 in the form of a sheet (without added Bio Oils in stage 6 above) was tested, the results are shown in Table 7:

TABLE 7
CHEMICAL PROPERTIES-RSC PLAST 10

| Parameter | Standard | Value | |
|---|---|---|---|
| Mooney viscosity | ASTM D1646 | 13 | |
| Ash, % | ASTM D297 | 7 | ±3 |
| Specific gravity | gm/cc | 1.12 | ±0.01 |

| | |
|---|---|
| Packaging: | Packing in white woven poly sacks on |
| | Standard wooden Pallet |
| Appearance: | Black slab |

The plasticizer of Example 2 in the form of a gel (Bio oil was added is stage 6 of the above process) was tested with the results shown in Table 8:

TABLE 8
CHEMICAL PROPERTIES-RSC PLAST 33

| Parameter | Standard | Value | |
|---|---|---|---|
| Mooney viscosity | ASTM D1646 | 9 | ±3 |
| Ash, % | ASTM D297 | 6 | ±2 |
| Specific gravity | gm/cc | 1.10 | ±0.01 |

| | |
|---|---|
| Packaging: | Packing in pre-weighed EVA pouches placed in white |
| | woven poly sacks on Standard wooden Pallet |
| Appearance: | Black Gel |

The plasticizer of Example 2 was named RSC Plast-10 and RSC Plast-33 (added oil) and tested with results shown in Table 9. A standard rubber formulation (LOW PCA OIL) is shown in the left most column of each table for comparison.

TABLE 9
RSC Plast Test Report

| | | | |
|---|---|---|---|
| | LOW PCA Oil | RSC Plast-10 | RSC Plast-33 |
| | 10 PHR | 10 PHR | (GEL) 10 |
| | & | & | PHR |
| TEST | Carbon 55 | Carbon 50 | & |
| DESCRIPTION | PHR | PHR | Carbon 50 PHR |

Rheological Properties

| | | | | |
|---|---|---|---|---|
| 1 | Temperature | 160 | 160 | 160 |
| | Arc | 3 | 3 | 3 |
| | Chart Speed | 25 | 25 | 25 |
| | Torque Range | 100 | 100 | 100 |
| | Scorch Time ts₂ | 4.03 | 3.75 | 3.25 |
| | Cure Time Tc₉₀ | 7.07 | 6.50 | 6.30 |
| | ML | 12.67 | 14.78 | 12.44 |
| | MH | 69.77 | 77.1 | 63.88 |

Physical Properties

| | | | | |
|---|---|---|---|---|
| 2 | Hardness | 59 | 63 | 58 |
| 3 | Tensile Strength | 170.48 | 168.65 | 172.81 |
| 4 | Elongation at Break | 557.61 | 524.13 | 645.07 |
| 5 | Modulus @ 100% | 16.79 | 19.21 | 15.09 |
| | Modulus @ 200% | 36.65 | 41.61 | 30.27 |
| | Modulus @ 300% | 67.06 | 74.82 | 53.58 |
| 6 | Specific Gravity | 1.12 | 1.12 | 1.12 |
| 7 | Abrasion Resistance | 63 | 68 | 67 |
| | Vol. Loss | | | |
| 8 | Tear Strength | 78.31 | 79.94 | 73.63 |

The test results demonstrate that rubber materials made using plasticizers of the invention preferably have similar properties to the standard material (Low PCA Oil 10 PHR & Carbon-55 PHR), is sustainable without any petroleum oils, is non-carcinogenic and can be manufactured at a lower cost.

### Example 3

Another example of a plasticizer composition of the invention is shown in Table 10:

TABLE 10

| Material | Wt. (kgs) | PHR |
|---|---|---|
| Whole tire TBR* 40 mesh | 1720 | 100.00 |
| Reclaiming agent (ADO**) | 20 | 1.16 |
| CNSL*** | 300 | 17.5 |
| | 2040 | 118.66 |

*Truck Bus Radial Tire Rubber.
**Alkylphenol Desulfurized Oligomer
***Cashew nutshell liquid

Below in Table 11 is the process used to manufacture the plasticizer of Example 3:

TABLE 11

| | Steps/Process | Time |
|---|---|---|
| 1 | All ingredients are loaded in the DV-rotary autoclave simultaneously. | 45 min |
| | Crumb, then oil, followed by a reclaiming agent. Additionally, 400 kg | |
| | of water was added. | |
| 2 | The vessel (DV) after having been loaded with rubber powder etc. is | 60 min |
| | heated from outside. (electrical coils) | |
| 3 | As soon as the temperature reaches @ 190° C. further heating is | 240 min |
| | stopped, and the material is allowed to cook for 4 hrs. (cooking time). | |
| 4 | Steam is released, and then the autoclave is opened to allow the | 45 min |
| | balanced moisture to escape. | |
| 5 | The bottom of the DV is opened, and the material is discharged to the | 30 min |
| | floor. The dump temperature is 40° C.-50° C. | |
| 6 | The material is moved to a mixing mill or a pre-refiner-about 1-2 | 5 min |
| | rounds forming sheets. | |
| 7 | After forming the sheet, the material is moved through a strainer | 5 min |
| | (using 40-60 mesh), and the noodles are formed. | |
| 8 | The material sheeting is carried on another similar refiner. | 5 min |
| 9 | The final material is packed as per the required quantity. | |

Final product properties: Moony viscosity is about 14 to 15.

The plasticizer of Example 3 was added into a rubber compound with the composition shown in Table 12 and test results shown in Table 13. A standard rubber formulation (with DTL) is shown in the column entitled “Running” for comparison.

TABLE 12

| | WITH | WITH |
|---|---|---|
| | DTL | RSC |
| Formulation | Running | Plast |
| Natural | 29.000 | 29.000 |
| Rubber | | |
| Reclaim | 6.800 | 6.800 |
| Rubber | | |
| PBR | 6.750 | 6.750 |
| Carbon HAF | 20.200 | 17.340 |
| RSC Plast | 0.000 | 7.000 |
| Oil 710 | 5.300 | 0.000 |
| 4020 | 0.310 | 0.310 |
| ZnAc | 1.500 | 1.500 |
| StAcid | 0.625 | 0.625 |
| Rozin | 0.700 | 0.700 |
| TDQ | 0.310 | 0.310 |
| P Wax | 0.310 | 0.310 |
| Ranacit | 0.043 | 0.043 |
| Zincolite | 0.590 | 0.590 |
| MRP 140 | 4.000 | 4.000 |
| Sulphur | 0.820 | 0.820 |
| TBBS | 0.357 | 0.357 |
| PVI | 0.083 | 0.083 |
| Total | 77.698 | 76.538 |

TABLE 13
Results

| | | | TEST RESULT | |
|---|---|---|---|---|
| | | | WITH | WITH |
| | | | DTL | RSC- |
| SR.NO | TEST DESCRIPTION | UNIT | Running | PLAST |
| 2 | Hardness | Shore A | 63 | 73 |
| 3 | Tensile Strength | kg/cm² | 171.12 | 173.36 |
| 4 | Elongation at Break | % | 532.59 | 403.99 |
| 5 | Modulus @ 100% | kg/cm² | 20.98 | 33.22 |
| | Modulus @ 200% | kg/cm² | 48.05 | 80.73 |
| | Modulus @ 300% | kg/cm² | 82.91 | 130.55 |
| 6 | Abrasion Resistance Vol. | mm³ | 112 | 101 |
| | Loss | | | |
| 7 | Tear Strength | kg/cm | 79.72 | 83.91 |

The test results shown above in Table 13 demonstrate that rubber materials made using the plasticizers of the invention (RSC Plast) preferably have higher modulus, comparable tensile strength, better abrasion better tear strength, and higher hardness that a standard formulation (with DTL) and is made without petroleum oil.

### Example 4

Another example of a plasticizer composition of the invention is shown in Table 14:

TABLE 14

| Material | Wt. (kgs) | PHR |
|---|---|---|
| RSC PLAST (Example 3) | 100 | 100.00 |
| CNSL*** | 5 | 5 |
| | 105 | 105 |

***Cashew nutshell liquid

Below in Table 15 is the process used to manufacture the plasticizer of Example 4:

TABLE 15

| | Steps/Process | Time |
|---|---|---|
| 1 | RCS Plast made in the Example 3 is stored for 23 days | — |
| 2 | Bio-oil CNSL is added on the RSC Plast while mixing on a two-roll | 3-5 minutes |
| | mill/refiner 5% on weight of Example 3 RSC Plast | |
| 8 | The mix was milled again | 3-5 minutes |
| 9 | The final material is packed as per the required quantity. | |

Final product properties: Mooney viscosity is about 9 to 11.

Plasticizer of Example 4 was added into 2 different rubber compounds suitable for passenger car radial tire the first shown in Table 16 and the second is the same with 5% added Bio-oil. The test results are shown in Table 17:

TABLE 16

| SR NO | INGREDIENTS | PHR |
|---|---|---|
| 1 | NATURAL RUBBER-4 | 25.000 |
| 2 | PBR-01 | 40.000 |
| 3 | SBR 1712 | 48.125 |
| 4 | ZINC OXIDE | 4.000 |
| 5 | STEARIC ACID | 2.000 |
| 6 | ANTIOXIDANT-TDQ | 1.000 |
| 7 | ANTIOZONANT- | 2.000 |
| | 6PPD(4020) | |
| 8 | MC WAX | 2.000 |
| 9 | CARBON BLACK IN-220) | 50.000 |
| 10 | RSC-PLAST-Ex. 4 | 10.000 |
| 11 | SULPHUR | 1.800 |
| 12 | CBS | 1.300 |
| 13 | DPG | 0.300 |
| 14 | PVI | 0.200 |

TABLE 17

| | TEST | TEST | | |
|---|---|---|---|---|
| S.NO. | DESCRIPTION | METHOD | TEST RESULTS | |
| 1. | Rheological Properties | ASTM-0- | Example 3 | Example 3. |
| | | 2084-19 | RSC Plast. | RSC Plast + |
| | | | | 5% added oil. |
| [symbol] | Rheological Parameters | | | |
| (a) | Temperature (° C.) | | 160 | 160 |
| (b) | Arc (Degree) | | 3 | 3 |
| (c) | Chart Speed (Min) | | 25 | 25 |
| (d) | Torque Range (libs.in) | | 100 | 100 |
| [symbol] | Rheological Values | | | |
| (a) | Scorch Time ts2 (Min) | | 2.87 | 2.93 |
| (b) | Cure Time Teao (Min) | | 5.07 | 5.18 |
| (c) | ML (lbs.in) | | 18.61 | 18.78 |
| (d) | MH (lbs.in) | | 77.66 | 77.77 |
| [symbol] | Curing Temperature | | 160 | 160 |
| | (° C.) | | | |
| [symbol] | Curing Time (Min) | | 10 | 10 |
| 2. | Hardness (Shore A) | ASTM D 2240-21 | 62 | 64 |
| 3. | Tensile Strength (kg/cm²) | ASTM D 412-21 | 161.98 | 161.90 |
| | (Test Method-A) | (Test Piece | | |
| | | Type-Die-C) | | |
| 4. | Elongation at Break(%) | ASTM D412-21 | 560.68 | 585.76 |
| | (Test Method-A) | (Test Piece | | |
| | | Type-Die-CJ | | |
| 5. | Modulus@ 100% | ASTM D 412-21 | 16.59 | 16.04 |
| | (kg/cm2) | | | |
| | | Type-Die-C) | | |
| 6. | Modulus@ 200% (kg/cm²) | ASTM D 412-21 | 37.31 | 34.25 |
| | (Test Method-A) | (Test Piece | | |
| | | Type-Die-C) | | |
| 7. | Modulus @ 300% (kg/cm²) | ASTM D 412-21 | 66.65 | 6140 |
| | (Test Method-A) | (Test Piece | | — |
| | | Type-Die-C) | | |
| 8. | Specific Gravity | ASTM D 297-21 | 1.11 | 1.12 |
| 9. | Abrasion Resistance Vol. | ASTM D 5963- | 62 | 68 |
| | Loss. (mm³) | 19 | | |
| 10. | Tear Strength (kg/cm) | ASTM D 624-20 | 81.24 | 78.45 |
| | | (Test Piece Type- | | |
| | | Die-C) | | |

The test results demonstrate comparable physical properties of two plasticizers of the invention in a vehicular radial tire.

The teachings of the inventions described in the specification are not limited to the preferred embodiments and examples but are intended to cover many modifications and equivalents consistent with the written description of the inventions as a whole as understood by one of ordinary skill in the relevant art in the field of the inventions.

1. A plasticizer comprising devulcanized rubber having a Mooney viscosity of about 20 or less.

2. The plasticizer of claim 1, wherein the Mooney viscosity is about 15 or less.

3. The plasticizer of claim 1, wherein the Mooney viscosity is about 12 or less.

4. The plasticizer of claim 1, wherein the form of the plasticizer is a gel, lump, sheet, string, noodle or pellet or a combination of these.

5. The plasticizer of claim 3, wherein the form of the plasticizer is a gel, lump, sheet, noodle, pellet, string or mix of the same.

6. The plasticizer of claim 1, further comprising a reclaiming agent.

7. The plasticizer of claim 2, further comprising a reclaiming agent.

8. The plasticizer of claim 3, further comprising a reclaiming agent.

9. The plasticizer of claim 6, wherein the form of the plasticizer is a gel, lump, sheet, noodle, pellet, string or mix of the same.

10. The plasticizer of claim 8, wherein the form of the plasticizer is a gel, lump, sheet, noodle, pellet, string or mix of the same.

11. The plasticizer of claim 6, wherein the reclaiming agent is an Alkylphenol Desulfurized Oligomer.

12. The plasticizer of claim 7, wherein the reclaiming agent is an Alkylphenol Desulfurized Oligomer.

13. The plasticizer of claim 8, wherein the reclaiming agent is an Alkylphenol Desulfurized Oligomer.

14. The plasticizer of claim 1, further comprising a Bio-oil.

15. The plasticizer of claim 2, further comprising a Bio-oil.

16. The plasticizer of claim 3, further comprising a Bio-oil.

17. The plasticizer of claim 14, wherein the Bio-oil is a cashew nutshell liquid.

18. The plasticizer of claim 15, wherein the Bio-oil is a cashew nutshell liquid.

19. The plasticizer of claim 16, wherein the Bio-oil is a cashew nutshell liquid.

20. The plasticizer of claim 1 comprising a devulcanized rubber at about 100 parts by weight, an Alkylphenol Desulfurized Oligomer at about 1 part by weight, and a cashew nutshell liquid at about 2.5 parts by weight.

21. The plasticizer of claim 20, wherein the Mooney viscosity is about 15 or less.

22. The plasticizer of claim 20, wherein the Mooney viscosity is about 12 or less.

23. A plasticizer of claim 1 comprising a devulcanized rubber at about 100 parts by weight, an Alkylphenol Desulfurized Oligomer at about 1 part by weight, and a cashew nutshell liquid at about 50 parts by weight.

24. The plasticizer of claim 23, wherein the Mooney viscosity is about 15 or less.

25. The plasticizer of claim 23, wherein the Mooney viscosity is about 12 or less.

26. A process of manufacturing a plasticizer comprising the steps of (1) passing a used rubber material through a mesh of at least about 30, (2) optionally adding a reclaiming agent, (3) heating to a temperature of at least about 130° C. while optionally applying pressure and mechanical shear until the Mooney viscosity of the plasticizer is about 20 or less and (4) transforming the plasticizer into a sheet, gel, lump, pellet, string or mix of the same.

27. The process of claim 26 wherein the Mooney viscosity is about 15 or less.

28. The process of claim 26 wherein the Mooney viscosity is about 12 or less.

29. A process of manufacturing a plasticizer comprising the steps of (1) passing a used rubber material through a mesh of at least about 30 and loading the resulting rubber material into an oxidizing and/or devulcanizing container, (2) adding a reclaiming agent into the oxidizing and/or devulcanizing container, (3) adding an Bio-oil into the oxidizing and/or devulcanizing container, (4) raising the temperature in the oxidizing and/or devulcanizing container to at least about 130° C. and maintaining that temperature while optionally applying mechanical shear and pressure until the Mooney viscosity of the plasticizer is about 20 or less, and (5) removing the plasticizer from the oxidizing and/or devulcanizing container and mechanically transforming the plasticizer material into a sheet, gel, lump, pellet, string or mix of the same and allowing the plasticizer to cool to room temperature.

30. The process of claim 29 wherein the Mooney viscosity of the plasticizer is about 15 or less.

31. The process of claim 29 wherein the Mooney viscosity of the plasticizer is about 10 or less.
